(19) United States
(12) Patent Application Publication
(10) Pub. No.: US 2020/0170768 A1
(43) Pub. Date: Jun. 4, 2020

(54) THREE-DIMENSIONAL CURING LIGHT

(71) Applicant: CAO Group, Inc., West Jordan, UT (US)

(72) Inventor: Densen Cao, Sandy, UT (US)

(21) Appl. No.: 16/784,753

(22) Filed: Feb. 7, 2020

Related U.S. Application Data
(63) Continuation-in-part of application No. 15/078,119, filed on Mar. 23, 2016, now abandoned.
Application No. 15/078,119 is a continuation of application No. 12/776,695, filed on May 10, 2010, now Pat. No. 9,295,537.
Application No. 12/776,695 is a continuation of application No. 11/445,498, filed on Jun. 1, 2006, now abandoned.
(60) Provisional application No. 60/686,261, filed on Jun. 1, 2005.

(51) Int. Cl. A61C 13/15; F21V 29/70

(52) U.S. Cl. CPC A61C 19/003; F21Y 2101/00; F21V 29/70

(57) ABSTRACT

A curing light may include a housing sized and configured for placement over a tooth. A first facet positioned within the housing may have a first LED mounted thereon, a second facet positioned within the housing may have a second LED mounted thereon, and a third facet positioned within the housing may have a third LED mounted thereon.

### CROSS-REFERENCE TO RELATED APPLICATIONS

This continuation application claims the benefit of and priority to U.S. patent application Ser. No. 15/078,119 titled THREE-DIMENSIONAL CURING LIGHT filed on Mar. 23, 2016 which is a continuation application of U.S. patent application Ser. No. 12/776,695 filed on May 10, 2010 which is in turn a continuation application of U.S. patent application Ser. No. 11/445,498 filed on Jun. 1, 2006 which claims priority to U.S. Provisional Patent Application Ser. No. 60/686,261 filed on Jun. 1, 2005. The content of each of the aforementioned applications is incorporated herein by reference in their entirety.

### TECHNICAL FIELD OF THE INVENTION

The present invention relates to the field of curing lights and, more particularly, to the field of three-dimensional curing lights.

### BACKGROUND OF THE INVENTION

Although teeth have a three-dimensional shape, prior art dental curing lights all emit light that can only be applied to one side of a tooth at a time. Exposing the entire tooth to light emitted by a curing light uses up valuable dentist chair time.

### SUMMARY OF THE INVENTION

A three-dimensional curing light is disclosed.

### BRIEF DESCRIPTION OF THE DRAWINGS

FIG. 1 depicts an example three-dimensional curing light.

FIG. 2 depicts a cross-sectional view of an example three-dimensional curing light.

FIG. 3 depicts another cross-sectional view of an example three-dimensional curing light.

### DETAILED DESCRIPTION OF THE INVENTION

Three-dimensional curing lights are disclosed that can emit light for polymerizing monomers into polymers from 3 sides of a tooth at the same time. This approach can also be used to enhance the properties of the cured dental composite, and to achieve a deeper cure.

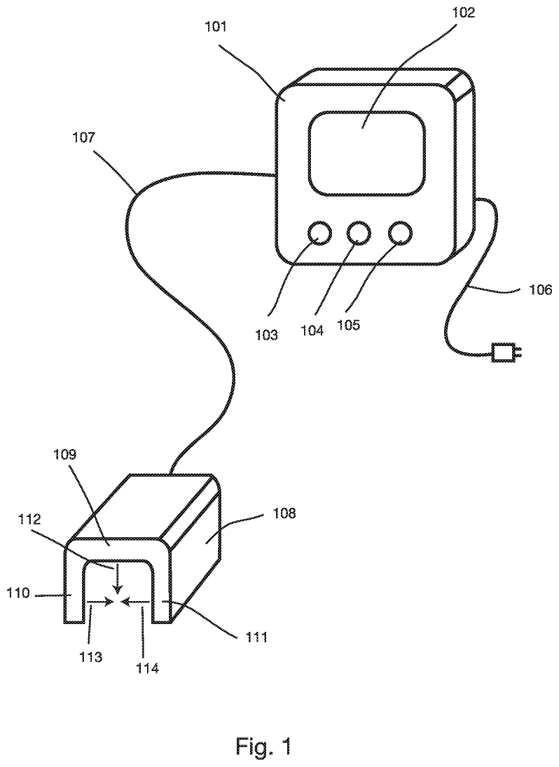

FIG. 1 depicts a perspective view of a three-dimensional curing light. A control box 101 controls operation of the light. It includes a display 102, control buttons 103, 104, and 105 for controlling power, curing mode, and light emitting selections respectively. An electrical cord 106 is attached to the control box 101 to provide electrical power from an AC outlet. A cable 107 transfers electrical power from the control box to a three-dimensional curing light head 108. The three-dimensional curing light head has 3 facets, 109, 110, and 111. The 3 facets form a three-dimensional channel. Inside the channel, the light is emitted from the inside of the facets. The light beams 112, 113, and 114 from each facet combine to cover the three-dimensional space occupied by a tooth. Thus, any three-dimensional object inside the channel can be cured at once. The light emitted from the 3 facets can be controlled to be emitted together or individually depending on the need.

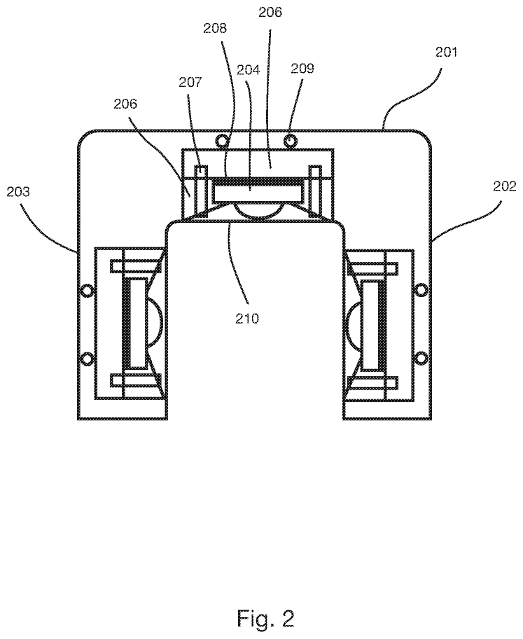

FIG. 2 depicts a cross-sectional view of a three-dimensional curing light head using LEDs as a light source. In the light head, there are 3 facets, 201, 202, and 203. Each facet has a similar structure and they are oriented at about 90 degrees to each other. The facets form a channel therebetween into which an object to be cured is placed. Each facet contains an LED light source 204. The LED light source can be a single LED, multiple LEDs, LED arrays, and combinations of different LEDs. The wavelength of the LEDs can range from less than 280 nm to more than 5000 nm depending on application. The power of the LEDs can range from less than 50 to more than 3000 mW/cm2. The LED light source is attached to a heat sink 205 using a fixture 206 with screw 207. There is heat conduction paste 208 located between LED 204 and heat sink 205 to facilitate heat transfer. There is a heat insulation layer 209 within the head housing to create an air gap between the heat sink and the outside casing so that the heat will not be conducted to the outside casing. On the light-emitting side of the LEDs, there is a protection cover 210 to cover the LEDs and protect them from damage and contaminants. The cover 210 can be a simple protection cover, or an optical lens to shape or focus a light beam. The LED light source can contain its own heat sink so that heat sink 205 serves as a secondary heat sink for greater heat dissipation. Instead of an LED light source, a semiconductor laser or any other desired light source could be used.

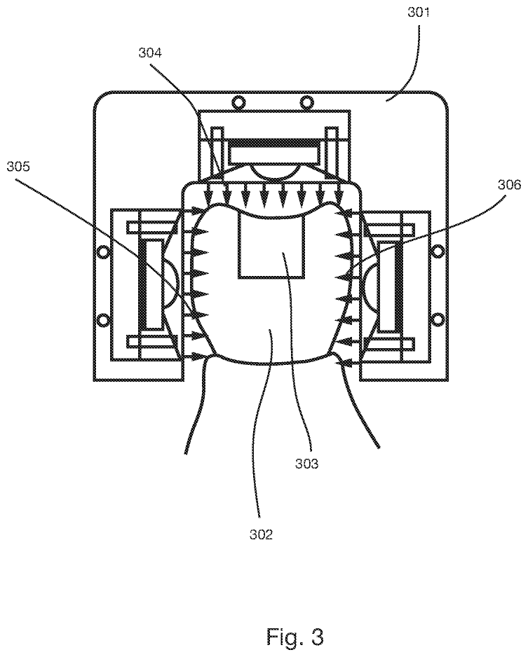

FIG. 3 depicts the curing of a tooth filling using a three-dimensional curing light. A light head 301 is on top of a tooth structure 302 with a filling 303 in the tooth. Three LEDs on 3 facets emit light beams 304, 305, and 306 from three sides. This allows the 3 light beams to reach the filling material from 3 directions to cure it into a durable dental restoration. Even though the light beams 305 and 306 need to penetrate the tooth structure to reach the filling material, the resulting dental restoration will be stronger and more durable than a restoration cured from one side only.

While the present invention has been described and illustrated in conjunction with a number of specific embodiments, those skilled in the art will appreciate that variations and modifications may be made without departing from the principles of the invention as herein illustrated, described, and claimed. The present invention may be embodied in other specific forms without departing from its spirit or essential characteristics. The described embodiments are to be considered in all respects as only illustrative, and not restrictive. All changes which come within the meaning and range of equivalency of the claims are to be embraced within their scope.

What is claimed is:

1. A method of tooth restoration, the method comprising:
a first step of preparing a caries afflicted tooth for restorative filling;
a second step of applying light curable restorative filling to the tooth; and,
a third step of utilizing a curing light to cure the restorative filling, said curing light emitting light onto the tooth and restorative filling from a plurality of different directions.

2. A method of tooth restoration, the method comprising:
a first step of preparing a caries afflicted tooth for restorative filling;
a second step of applying light curable restorative filling to the tooth;
a third step of positioning a curing light over the tooth to cure the restorative filling, said curing light further comprising:
a housing sized and configured for placement over the tooth;
a first facet positioned within the housing having a first LED mounted thereon, said first facet configured to face a crown of the tooth when the housing is placed over the tooth;
a second facet positioned within the housing having a second LED mounted thereon, said second facet configured to face a first exposed side of the tooth when the housing is placed over the tooth; and
a third facet positioned within the housing having a third LED mounted thereon, said third facet configured to face a second exposed side of the tooth when the housing is placed over the tooth, said second exposed side of the tooth being opposite of said first exposed side; and
a fourth step of emitting light onto the tooth and the restorative filling from each facet of the curing light.

3. A method of tooth restoration, the method comprising:
a first step of preparing a caries afflicted tooth for restorative filling;
a second step of applying light curable restorative filling to the tooth; and
a third step of utilizing a curing light to cure the restorative filling, said curing light emitting light onto the tooth and restorative filling from a plurality of different directions and a portion of said emitted light passing through at least a portion of tooth structure before it reaches the restorative filling and cures said filling.
